(19) United States
(12) Patent Application Publication
(10) Pub. No.: US 2025/0342525 A1
(43) Pub. Date: Nov. 6, 2025

(54) METHOD AND SYSTEM FOR ASSESSING CREDIT SCORE OF A USER IN REAL-TIME

(71) Applicant: Worth AI, Orlando, FL (US)

(72) Inventors: Jacques Fu, Orlando, FL (US); Arya Eskamani, Orlando, FL (US); Mats Lunde, Orlando, FL (US)

(21) Appl. No.: 19/196,019

(22) Filed: May 1, 2025

Related U.S. Application Data
(60) Provisional application No. 63/640,887, filed on May 1, 2024.

(51) Int. Cl. G06Q 40/03

(52) U.S. Cl. CPC G06Q 40/03

(57) ABSTRACT

A method and system for credit score computation in real-time is disclosed. Financial data received from a plurality of disparate data sources is aggregated to generate a unified data structure. A monotonic neural network model, comprising weight matrices with Lipschitz constraints and a group activation function, is applied to the unified data structure to compute a credit score. A plurality of features influencing the credit score are extracted from the unified data structure, and feature contribution scores quantifying magnitude and directionality of impact are generated for each of the plurality of features on the credit score, using an explainable artificial intelligence (XAI) component. A set of credit enhancement actions and corresponding projected impact values are identified based on the feature contribution scores, using a language action model (LAM), and are presented to the user via a user interface (UI).

### FIELD

Various embodiments of the present disclosure generally relate to credit scores. More particularly, the disclosure relates to a method and system for computation of credit score of a user in real-time using monotonic neural networks and providing explanations along with credit enhancement actions and recommendations to the user to improve the credit score.

### BACKGROUND

Credit scores serve as critical metrics in financial transactions, providing lenders with insights into an individual's creditworthiness. The credit scores are essential for assessing the risk associated with extending credit, thereby influencing decisions regarding loans, mortgages, and credit card approvals. Additionally, credit scores often influence the terms and conditions of credit offerings, including interest rates and credit limits.

Numerous methodologies and systems exist for calculating credit scores, each employing distinct algorithms and data sources. Leading credit score generation companies play a pivotal role in the credit ecosystem, which integrate information from credit reports, including payment history, credit utilization, length of credit history, new credit accounts, and credit mix.

While existing credit scoring systems have proven effective, they often rely on historical and static data provided by financial institutions. This reliance on outdated information can result in delayed and potentially inaccurate credit scores for individuals. Moreover, these systems lack transparency, making it challenging for individuals to understand how their credit scores are calculated and what factors influence them.

Further, existing credit scoring systems may fail to provide actionable insights for individuals to improve their credit scores effectively. While individuals may receive numerical scores, they often lack clear guidance on how to address deficiencies in their credit profiles. This deficiency deprives consumers of the tools needed to take proactive steps towards enhancing their creditworthiness.

Further, recent advancements in artificial intelligence and machine learning have led to the development of neural network-based credit scoring models. However, the advancements based on neural network-based scoring models actually tend to face challenges related to convergence. Standard neural network-based activation functions like ReLU, which are commonly used in these networks, suffer from issues like vanishing gradients when partial derivatives approach zero. This leads to slow or stalled training, particularly when large portions of the model's weights become inactive. The inefficiencies not only hinder the model's performance but also delay the generation of reliable credit scores.

Furthermore, traditional neural network-based scoring models, however, often fail to provide intuitive and consistent outputs that align with certain financial expectations, such as the notion that a business with higher revenue should always receive a higher credit score than a business with lower revenue, assuming all other factors are equal. Achieving this form of monotonicity in a neural network, where the output consistently moves in a predictable direction relative to the input, is crucial for interpretability and user trust in the model.

Existing neural networks are not inherently monotonic, meaning that input changes can lead to unpredictable variations in the output. To enforce monotonic behavior, two primary approaches exist: by construction, which involves modifying the network architecture to enforce monotonic constraints, and by regularization, where the loss function punishes non-monotonicity. While the regularization approach is easier and quicker to implement, it does not guarantee monotonicity, making the construction approach more reliable, albeit more complex.

There is, therefore, a need for a credit scoring system that can dynamically perform real-time credit assessments based on up-to-date information and enhance transparency by furnishing detailed information on how credit scores are calculated and offer actionable insights to users to take proactive actions corresponding to the recommendations.

### SUMMARY

The present disclosure provides a method and system for credit score computation in real-time. Financial data received from a plurality of disparate data sources is aggregated to generate a unified data structure. A monotonic neural network model is applied to the unified data structure to compute a credit score. The monotonic neural network model includes weight matrices with Lipschitz constraints ensuring bounded output changes for any input perturbation, and a GroupSort activation function that maintains unit gradient over its domain. A plurality of features influencing the credit score are extracted from the unified data structure, and feature contribution scores quantifying magnitude and directionality of impact are generated for each of the plurality of features on the credit score, using an explainable artificial intelligence (XAI) component.

A set of credit enhancement actions and corresponding projected impact values are identified based on the feature contribution scores, using a language action model (LAM), and are presented to the user via a user interface.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary embodiment within which various embodiments of the present disclosure may function.

FIG. 2 is a diagram that illustrates a system for computation of credit scores of a user, in accordance with an embodiment of the disclosure.

FIG. 3 is a diagram that illustrates a flowchart with method for computation of credit scores of a user, in accordance with an embodiment of the disclosure.

### DETAILED DESCRIPTION

Pursuant to various embodiments, the present disclosure relates to a method and system for credit score computation in real-time. Financial data received from a plurality of disparate data sources is aggregated to generate a unified data structure. A monotonic neural network model is applied to the unified data structure to compute a credit score. The monotonic neural network model includes weight matrices with Lipschitz constraints ensuring bounded output changes for any input perturbation, and a GroupSort activation function that maintains unit gradient over its domain. A plurality of features influencing the credit score are extracted from the unified data structure, and feature contribution scores quantifying magnitude and directionality of impact are generated for each of the plurality of features on the credit score, using an explainable artificial intelligence (XAI) component. A set of credit enhancement actions and corresponding projected impact values are identified based on the feature contribution scores, using a language action model (LAM), and are presented to the user via a user interface.

In one or more embodiments, credit score refers to a numerical representation or rating assigned to an individual, business, or entity, which reflects their creditworthiness based on various financial data inputs. For instance, the credit score of an entity can be derived from an analysis of factors such as payment history, debt-to-income ratio, credit utilization, and other relevant financial behaviors.

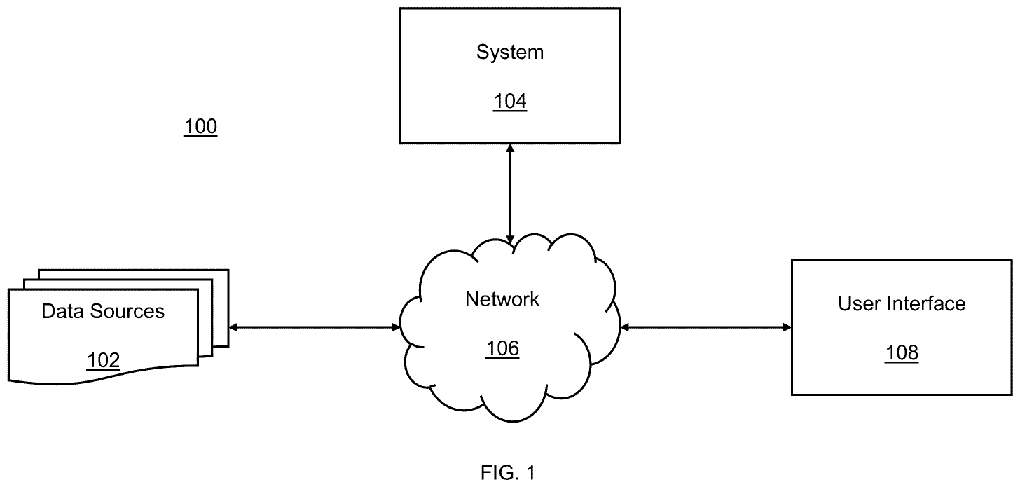

FIG. 1 is a diagram that illustrates an exemplary environment 100 within which various embodiments of the present disclosure may function. Referring to FIG. 1 the environment 100 comprises data sources 102, a system 104, a network 106, and a user interface (UI) 108.

Data sources 102 encompass disparate sources of information related to financial transaction data from banking systems, credit report data from credit bureaus, asset ownership records, and business revenue data.

In some non-limiting embodiments, the aforementioned data sources 102 are presented as exemplary and are not intended to limit the scope of potential sources. The data sources 102 may include, but are not limited to, a wide range of financial information from various domains. Other sources such as transaction histories from peer-to-peer lending platforms, utility payment records (e.g., electricity, water, telecommunications), rental payment history, tax records, insurance premiums, and social media-based financial behavior data may also be incorporated.

The system 104 is configured to gather and analyze data from the disparate data sources 102 to compute credit scores for users in real-time. It leverages the integration of artificial intelligence (AI) and machine learning (ML) models, along with features for XAI and LAM capabilities. The system 104 extracts relevant user attributes, such as financial transaction details, credit histories, asset ownership, and other pertinent data, which are processed using AI and ML algorithms to generate accurate, real-time credit scores.

In an exemplary embodiment, a LAM refers to a component or framework within the system 104 designed to process and analyze natural language inputs related to user financial data, credit enhancement actions, or credit score-related queries. LAM utilizes natural language processing (NLP) techniques and ML algorithms to interpret user intents, extract relevant information, and generate actionable insights in a user-friendly manner. Additionally, LAM may enable features such as conversational interfaces, where users can ask questions about their credit scores or seek guidance on improving their financial health.

In an exemplary embodiment, XAI refers to a set of methodologies integrated into the system 104 to enhance the interpretability and transparency of AI-driven processes. XAI provides users with clear, understandable explanations of how their credit scores are computed and the specific factors influencing the outcome.

In one or more embodiments, the system 104 is further configured to present users with a set of actionable credit enhancement recommendations, each accompanied by corresponding projected impact values. The recommendations are tailored based on the user's current financial profile and credit score factors, providing clear guidance on specific steps the user can take to improve credit worthiness. The projected impact values offer an estimate of how each action such as reducing credit utilization, improving payment history, or diversifying credit types could positively influence the user's credit score.

The network 106 includes communication networks operable to facilitate communication, either wirelessly or wired. The network 106 connects a plurality of computer systems. The network 106 may comprise, for example, an intranet, local area network, wide area network, the internet, or other wireless networks.

In one or more embodiments, the network 106 facilitates connection between the system 104 and the UI 108 via one or more communication channels.

In one or more embodiments, the UI 108 is configured to display the identified set of credit enhancement actions along with their corresponding projected impact values to the user. The UI 108 can be designed to include, but is not limited to, an intuitive web-based dashboard, a mobile application interface, or an integrated financial management portal. The UI 108 is tailored to provide users with a seamless and interactive experience, incorporating features such as dynamic visualizations, real-time updates, and actionable insights.

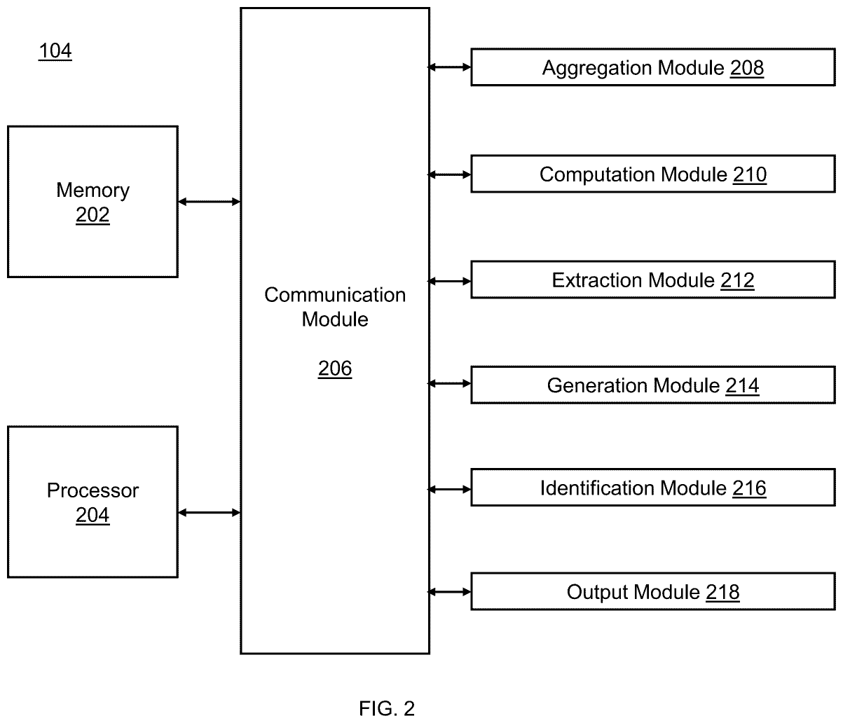

FIG. 2 is a diagram that illustrates the system 104 for assessing credit scores of a user, in accordance with an embodiment of the disclosure. Referring to FIG. 2, the system 104 comprises a memory 202, a processor 204, a communication module 206, an aggregation module 208, a computation module 210, an extraction module 212, a generation module 214, an identification module 216, and an output module 218.

The memory 202 may comprise suitable logic, code, and/or interfaces that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 104 in accordance with various aspects of the present disclosure. The processor 204 may be further configured to communicate with the various modules of the system 104 through the communication module 206, which manages internal and external data communications.

The system 104, upon receiving data from the data sources 102, initiates the aggregation module 208 incorporated with suitable logic, code, and/or interfaces, to aggregate the received data and generate a unified data structure.

In one or more embodiments, generating the unified data structure by the aggregation module 208 involves a multi-step process for seamless integration and usability of data from the plurality of disparate data sources 102. The multi-step process includes standardizing data formats by converting diverse input structures into a consistent schema, allowing uniform interpretation and processing across the system 104. It further includes resolving conflicts that may arise from overlapping or redundant data provided by different sources, employing techniques such as priority rules, weighted averages, or ML algorithms to reconcile discrepancies and determine accurate and reliable data.

Additionally, the aggregation module 208 identifies and addresses missing or incomplete data by employing imputation techniques, predictive modeling, or external data augmentation to fill gaps while preserving data integrity. Throughout the process, the aggregation module 208 maintains data consistency across all data sources 102, implementing validation checks and synchronization mechanisms to align updates and changes in real-time.

The computation module 210 may comprise suitable logic, code, and/or interfaces that may be configured to compute a credit score by applying a monotonic neural network model to the unified data structure.

In one or more embodiments, the computation module 210 leverages the monotonic neural network's ability to enforce constraints on specific input attributes, so that the computed credit score behaves predictably and aligns with intuitive financial principles. For instance, the monotonic constraints ensure that an increase in positive financial indicators, such as revenue or timely payment history, results in a higher credit score.

In one or more embodiments, the computation module 210 processes the standardized data from the unified data structure to extract relevant features and applies advanced neural network techniques, including Lipschitz-constrained weights and the GroupSort activation function, to achieve accurate and reliable credit score computations.

In one or more embodiments, the monotonic neural network model comprises weight matrices with Lipschitz constraints, which facilitates that the network's gradient does not exceed a predefined upper bound. Specifically, the monotonic neural network enforces a Lipschitz constant of 1, meaning that for any two input values x₁ and x₂, the difference in their corresponding outputs remain bounded. This constant ensures that output changes remain stable and predictable in response to perturbations in the input data, effectively preventing large fluctuations. Additionally, the monotonic neural network model incorporates a GroupSort activation function, which maintains a unit gradient over its entire domain, thereby facilitating smooth and consistent learning.

In one or more embodiments, the monotonic neural network model implements Lipschitz constraints constraining the weight matrix across different layers. Specifically, in the input layer, each weight matrix is normalized by dividing each element by its absolute value, so that the weights have an absolute magnitude of 1, which corresponds to the predefined Lipschitz constant. In subsequent layers, each column of the weight matrix is normalized by dividing it by the sum of its absolute values, thereby preserving the Lipschitz constraint across layers. To prevent division by zero, a small numerical threshold of 1e−10 is applied as the minimum denominator value. This normalization process confirms that the influence of each feature is appropriately scaled, preventing large, disproportionate output changes in response to small input variations, and maintaining bounded sensitivity to input perturbations.

In one or more embodiments, the monotonic neural network model implements the GroupSort activation function, which enhances the model's ability to handle high-dimensional input data while mitigating gradient attenuation. GroupSort divides the input vectors into sub-vectors of length 2 and performs internal sorting of the elements within each sub-vector. The sorting mechanism helps preserve the relative importance of the features within each segment, while maintaining a unit gradient across the function's domain. By using a fixed sub-vector length of 2, GroupSort ensures that gradients do not diminish excessively as the network depth increases, thereby retaining the expressivity of the model compared to traditional activation functions such as ReLU.

The extraction module 212 may comprise suitable logic, code, and/or interfaces that may be configured to extract a plurality of features from the unified data structure that are influencing the credit score. The extraction process involves identifying and selecting relevant attributes, such as financial transaction patterns, credit utilization rates, payment histories, and asset ownership records, which have a direct impact on the credit score computation.

In some non-limiting embodiments, the extraction module 212 applies one or more feature selection techniques to consider the most significant features, while irrelevant or redundant data is filtered out, to enable the system 104 to focus on factors that provide the most predictive value in determining creditworthiness.

The generation module 214 may comprise suitable logic, code, and/or interfaces that may be configured to generate feature contribution scores quantifying magnitude and directionality of impact for each of the plurality of features on the credit score. The magnitude of the impact indicates the degree of influence a particular feature, such as payment history or credit utilization, exerts on the computed credit score, while the directionality of the impact denotes whether the feature positively or negatively impacts the score.

In one or more embodiments, the generation module 214 utilizes the XAI component to generate the feature contribution scores. The XAI component is configured to analyze the internal workings of the monotonic neural network model used in credit score computation, providing detailed insights into the role of each feature in influencing the final credit score. While the system 104 currently employs techniques such as, SHAP (Shapley Additive Explanations) values for explainability, the approach is adaptable to other suitable techniques such as LIME (Local Interpretable Model-agnostic Explanations), or Integrated Gradients. These techniques quantify both the magnitude and direction (positive or negative) of each feature's impact.

It should be noted that while certain embodiments describe the use of SHAP values for explainability, the disclosure is not limited to this technique. In some non-limiting embodiments, the system 104 may employ any alternative or additional explainability methods.

In an exemplary embodiment, features such as ‘payment history’ and ‘credit utilization’ are assigned contribution scores that indicate how much they contribute to increasing or decreasing the user's credit score. The XAI component enables transparency by breaking down the complex computations of the neural network into an interpretable format, enabling both the user and stakeholders to understand the factors affecting the credit score.

In accordance with the exemplary embodiment, by leveraging SHAP explainability, contribution scores assigned to the ‘payment history’ and ‘credit utilization’ are computed based on:

$${ϕ}_{i} = {\sum }_{S ⊆ \{ 1 , … , p \} \backslash \{ i \}} \frac{\vert S \vert ! ( p - \vert S \vert - 1 ) !}{p !} ( val ( S ⋃ \{ i \} ) - val ( S ) ) .$$

In some non-limiting embodiments, the equations used for computing contribution scores are not limited to, and may vary based on the specific explainability technique employed.

In one or more embodiments, the generation module 214, to generate the feature contribution scores, computes a quantitative measure of influence for each of the plurality of features on the credit score, which determines the extent to which each feature contributes to the overall score and whether its influence is positive, enhancing the credit score, or negative, detracting from it. The generation module 214 may perform the analysis by leveraging mathematical and machine learning techniques, such as sensitivity analysis, gradient-based attribution, or explainability metrics like Shapley values.

For instance, features such as payment history and credit utilization are analyzed to quantify their exact contribution in terms of score increments or decrements. A feature with a positive contribution, such as a long history of on-time payments, would be identified as a factor increasing the credit score, while a feature with a negative contribution, such as high credit utilization, would be flagged as reducing the credit score.

Thereafter, the generation module 214 ranks the plurality of features based on their respective quantitative measures of influence on the credit score, which involves ordering the features in descending or ascending order, depending on their magnitude of influence, to highlight the most impactful features. Features with a higher quantitative measure of positive influence, such as a strong history of on-time payments or low credit utilization, are ranked higher, while those with a greater negative influence, such as recent defaults or excessive credit inquiries, are ranked lower.

The identification module 216 may comprise suitable logic, code, and/or interfaces that may be configured to identify a set of credit enhancement actions based on the feature contribution scores. The identification module 216 analyzes the ranked features and their respective quantitative measures of influence to determine actionable steps that the user can take to improve credit score.

For instance, if the feature contribution score highlights that ‘high credit utilization’ is negatively impacting the credit score, the identification module 216 may recommend actions such as reducing outstanding balances or requesting a higher credit limit to improve the utilization ratio. Similarly, if ‘on-time payments’ is identified as a significant positive influence, the identification module 216 might suggest automating payments to ensure continued timeliness.

In one or more embodiments, the identification module 216 identifies the set of credit enhancement actions by analyzing the feature contribution scores to identify features having negative impact on the credit score to determine specific actions that can improve the identified features.

For example, if the analysis reveals that a feature such as ‘high credit utilization’ is contributing negatively, the identification module 216 may suggest actions such as reducing outstanding balances, consolidating debt, or increasing the available credit limit. Similarly, if a negatively contributing feature such as ‘frequent hard credit inquiries’ is detected, the identification module 216 might recommend avoiding new credit applications for a certain period to mitigate its impact.

The identification module 216 leverages the quantitative measures of influence associated with each feature, ensuring that the recommended actions are both relevant and impactful. In one or more embodiments, this process is further refined by the integration of advanced AI algorithms, which not only identify the features but also simulate the potential outcomes of various corrective actions. This enables the system 104 to recommend actions that are optimal for the user's specific financial situation.

The identification module 216 then estimates an expected credit score improvement for each specific action. The estimation involves calculating the potential positive impact of implementing the recommended action on the user's credit score. For instance, if reducing credit utilization is identified as an actionable step, the identification module 216 may calculate the projected increase in the credit score based on the percentage reduction in utilization.

To perform this estimation, the identification module 216 leverages historical data patterns, predictive algorithms, and the feature contribution scores generated by the system 104. It simulates hypothetical scenarios by modifying the values of negatively influencing features to reflect the effect of the corrective action. For example, by modeling a reduction in missed payments or an increase in payment consistency, the identification module 216 can predict how the user's credit score is likely to improve.

In some non-limiting embodiments, the identification module 216 utilizes a LAM to identify the set of credit enhancement actions. The LAM leverages a trained LLM based on transformer architecture, which inherently incorporates various NLP techniques for contextual understanding. By analyzing the feature contribution scores, the LLM interprets the specific credit improvement needs of the user. Through fine-tuning and integration with the LAM process, the LLM identifies features that negatively impact the credit score and determines corresponding corrective actions.

For instance, if the feature contribution scores indicate a negative influence due to high credit utilization, the LAM may recommend actions such as reducing credit card spending or increasing the credit limit on specific accounts. Similarly, for missed payments, the LAM may suggest setting up payment reminders or automating bill payments.

In some non-limiting embodiments, the LAM not only identifies actionable recommendations but also generates human-readable descriptions for these actions, ensuring clarity and accessibility for the user. The LAM is trained to produce recommendations in a manner consistent with how a relevant user such as a credit analyst, risk manager, or chief risk officer would articulate them. By leveraging its trained language generation capabilities, the LAM contextualizes the recommendations based on the user's financial history, preferences, and behavioral patterns so that the suggestion are both relevant and interpretable.

In one or more embodiments, the system 104 is configured to generate, for each credit enhancement action in the identified set, an explanation of causative relationship between the credit enhancement action and potential credit score improvement, a quantitative projection of expected credit score change, and a sequence of steps required for action execution.

In one or more embodiments, the system 104 provides a clear and intuitive explanation of how the proposed credit enhancement action influences the user's credit score. For instance, if the action involves reducing credit utilization, the system 104 explains how lowering the ratio of utilized credit to available credit improves creditworthiness as perceived by the scoring algorithm. The explanation highlights the specific feature(s) contributing negatively and how the action addresses those aspects.

In one or more embodiments, the system 104 calculates and presents a numerical projection of the expected credit score improvement resulting from the execution of the recommended action. This projection is derived using the feature contribution scores and the underlying monotonic neural network model. For example, if reducing credit utilization by 20% is expected to result in a 30-point increase in the credit score, this quantitative impact is explicitly communicated to the user.

In one or more embodiments, the system 104 outlines a step-by-step guide for implementing the recommended action. This sequence is designed to ensure that users can easily understand and execute the action effectively. For example, if the action involves consolidating debt, the system 104 may suggest steps such as reviewing existing loan terms, comparing consolidation offers, and submitting an application for a consolidation loan.

The output module 218 may comprise suitable logic, code, and/or interfaces that may be configured to present the identified set of credit enhancement actions and corresponding projected impact values to the user via the UI 108

In one or more embodiments, the output module 218 formats and organizes the data into a user-friendly and intuitive display, ensuring that the user can easily interpret the recommendations. For instance, the presentation may include a concise and clear description of each recommended credit enhancement action, such as, reduce outstanding credit card balance by 20%, quantitative projections indicating the estimated improvement in the user's credit score for each action, graphical elements such as bar charts, pie charts, or progress indicators may be used to visually represent the relative impact of each action on the credit score. Further, the output module 218 may rank the actions in order of their projected impact, enabling the user to focus on the most effective steps first.

The system 104 is further configured to facilitate the execution of credit enhancement actions by interacting with the UI 108. Specifically, the system 104 enables the user to review the identified set of credit enhancement actions and, via the UI 108, select one or more actions for implementation. Upon receiving the user's selection, the system 104 generates and dispatches one or more Application Programming Interface (API) calls to the relevant external systems, platforms, or service providers necessary for executing the selected credit enhancement actions.

For example, if the selected action involves reducing a credit card balance, the system 104 may generate an API call to the user's financial institution to initiate a payment or update the balance. Similarly, for actions like disputing an inaccurate credit report entry, the system 104 may generate an API call to the appropriate credit bureau to file a dispute.

Once the API calls are executed, the system 104 monitors the status to determine whether the actions have been successfully completed. Based on the executed status of the API calls, the system 104 dynamically updates the user's credit score in real-time. The update reflects the impact of the actions executed, confirming that the credit score is an accurate and up-to-date representation of the user's financial standing.

In one or more embodiments, the system 104 is configured to generate one or more API calls by ensuring compliance with the specifications of the target financial systems. This process involves formatting API requests to align with the data structures, authentication protocols, and operational requirements defined by the respective financial systems or service providers. To maintain the integrity and confidentiality of the transmitted data, the system 104 establishes secure connections with the target financial systems using industry-standard encryption protocols.

Once the API requests are properly formatted and securely transmitted, the system 104 interacts with the target financial systems to perform the required actions. The actions may include querying account balances, initiating transactions, filing disputes, or any other operations relevant to the selected credit enhancement actions. The system 104 continuously monitors the interaction to ensure the successful execution of the API calls and subsequently receives validated responses from the target systems. The responses may include confirmations of action completion, status updates, or additional information necessary for updating the user's credit score or providing further recommendations.

The system 104 is further configured to monitor, in real-time, updates or changes occurring within the financial data retrieved from the plurality of data sources 102. This real-time monitoring involves analyzing the incoming data streams for significant changes in one or more of the plurality of features that contribute to the credit score. Significant changes may include, but are not limited to, fluctuations in income, variations in debt levels, updates to payment histories, or changes in asset ownership. Thresholds defining a significant change may be set by default or customized by the user. For instance, the system 104 may generate an alert when newly integrated data reveals critical events such as a lien or judgment. Additionally, threshold-based alerts can be triggered by specific variations in the credit score, such as a predefined drop of 20 points or 10 percent. The system 104 utilizes advanced data processing techniques to identify these changes, ensuring that only meaningful variations trigger further analysis.

Upon detecting such significant changes, the system 104 automatically initiates a recomputation of the credit score, which involves reapplying the monotonic neural network model to the updated unified data structure, ensuring that the credit score remains accurate and reflective of the most current financial situation. The recomputation is triggered by the ingestion of new data or changes in existing input values, allowing the system 104 to continuously update scores as new financial information becomes available. This dynamic updating mechanism addresses a common limitation in small and medium businesses (SMB) credit assessments, where credit determinations are often static and based on potentially outdated data at the time of evaluation. By ensuring real-time recomputation, the system 104 mitigates the risk of credit decisions being made based on obsolete information. Simultaneously, the system 104 recomputes the feature contribution scores, recalculating the magnitude and directionality of each feature's influence on the updated credit score.

### Exemplary Embodiment

Consider an exemplary scenario where a customer wishes to understand his credit score to prepare for applying for a home loan in the near future. The customer's financial data is scattered across multiple sources, including his bank accounts, credit card issuers, credit bureaus, and income records from his employer.

The system 104 is employed to assess the customer's creditworthiness and provide actionable recommendations for improving his credit score.

The process begins with the aggregation module 208, which collects data from disparate data sources 102. The system 104 accesses the customer's transaction history from his bank, his credit utilization and repayment history from credit card providers, his credit reports from credit bureaus, and his verified income details from his employer's payroll system. The aggregation module 208 standardizes the data formats, resolves inconsistencies (e.g., differing income records reported by multiple sources), and handles missing data points, such as filling in gaps in his recent credit card usage history.

Next, the computation module 210 processes the unified data structure to compute the customer's credit score. The computation module 210 uses a monotonic neural network model, which ensures that any small variations in the customer's input data (such as slight increases in income or reductions in debt) produce proportional and predictable changes in the output credit score. The monotonic neural network model's Lipschitz-constrained weight matrices and GroupSort activation function ensure stability and interpretability during computation.

After computation, the system (104) determines that:
the customer's credit score is 620.

However, to qualify for the desired home loan:
a minimum score of 750 is required.

The system 104 identifies that the customer's current score is 20% lower than what is necessary to proceed with the loan application.

To understand why the customer's credit score is below the required threshold, the extraction module 212 analyzes the unified data structure and extracts the key features impacting the score. The extraction module 212 identifies that the customer's high credit card utilization (70%), a recent late payment on a loan, and a lack of diverse credit types (e.g., no history of managing installment loans) are the primary factors negatively affecting his score.

The generation module 214 calculates feature contribution scores for each of the extracted features. For example, it determines:
that high credit card utilization contributes negatively by 50 points,
the recent late payment reduces the score by 30 points, and
the lack of credit diversity contributes negatively by 20 points.

The generation module 214 also quantifies the positive impacts of the customer's timely payments in other areas and his consistent income, which contribute positively to the score. The contribution scores provide a clear breakdown of how each feature influences the customer's credit score.

Based on the feature contribution scores, the identification module 216 analyzes potential actions that the customer can take to improve his credit score.

For instance:
Reducing his credit card utilization from 70% to below 30% could increase his score by 40 points.
Setting up automatic payments to avoid future late payments could prevent additional score reductions and gradually improve his score by 15 points over time. Applying for a small installment loan and managing it responsibly could improve credit diversity, adding 20 points to his score.

The identification module 216 estimates that, collectively, these actions could raise the customer's score by up to 75 points, bringing him closer to the required score for the loan.

The output module 218 presents the findings and recommendations to the customer via the UI 108. The UI 108 displays:
The customer's current credit score of 620, the threshold score of 750 required for the loan, and a detailed breakdown of the negative and positive feature contributions.

Additionally, the output module 218 presents the identified credit enhancement actions, their estimated impact on his score, and a step-by-step guide for executing these actions.

The customer selects the recommended action to reduce his credit card utilization by paying down a portion of his outstanding balance. The system 104 generates an API call to interact with his credit card provider, executes the payment, and monitors the updated utilization data.

The system 104 continues to monitor changes in the customer's financial data in real time. When the credit card utilization data reflects the reduced balance, the aggregation module 208 updates the unified data structure, and the computation module 210 recalculates John's credit score. The new score, along with updated feature contribution scores, is displayed to the customer, showing his progress toward achieving the required score for the loan.

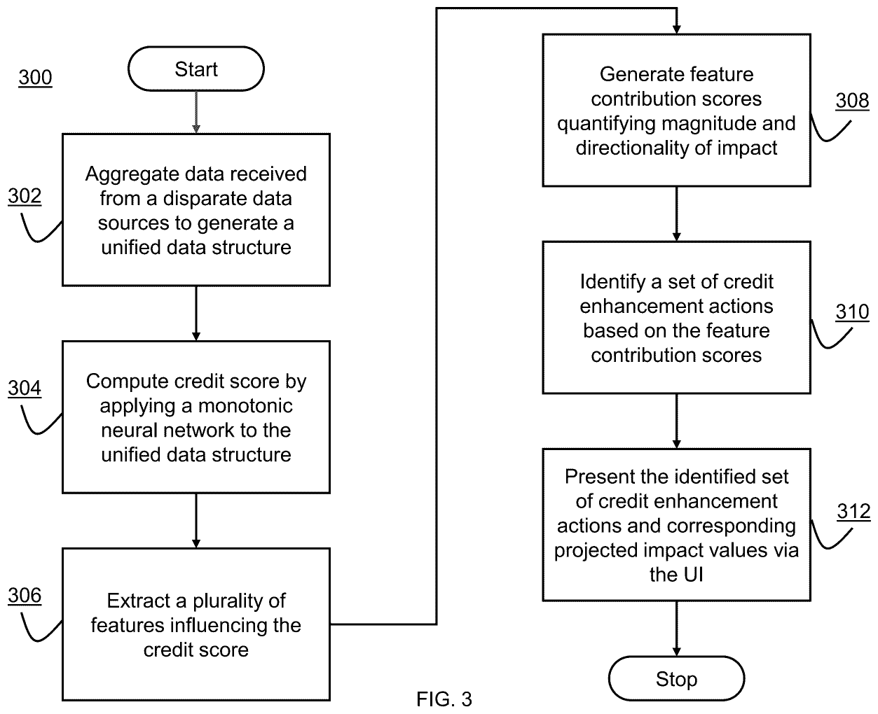

FIG. 3 is a diagram that illustrates a flowchart 300 with a method for computation of credit scores of a user, in accordance with an embodiment of the disclosure.

At 302, the system 104, upon receiving data from the data sources 102, initiates the aggregation module 208 to aggregate the received data and generate a unified data structure.

In one or more embodiments, generating the unified data structure by the aggregation module 208 involves a multi-step process for seamless integration and usability of data from the plurality of disparate data sources 102. The multi-step process includes standardizing data formats by converting diverse input structures into a consistent schema, allowing uniform interpretation and processing across the system 104. It further includes resolving conflicts that may arise from overlapping or redundant data provided by different sources, employing techniques such as priority rules, weighted averages, or ML algorithms to reconcile discrepancies and determine accurate and reliable data.

At 304, the computation module 210 computes the credit score by applying the monotonic neural network model to the unified data structure.

In one or more embodiments, the computation module 210 leverages the monotonic neural network's ability to enforce constraints on specific input attributes, so that the computed credit score behaves predictably and aligns with intuitive financial principles. For instance, the monotonic constraints ensure that an increase in positive financial indicators, such as revenue or timely payment history, results in a higher credit score.

In one or more embodiments, the computation module 210 processes the standardized data from the unified data structure to extract relevant features and applies advanced neural network techniques, including Lipschitz-constrained weights and the GroupSort activation function, to achieve accurate and reliable credit score computations.

In one or more embodiments, the monotonic neural network model comprises weight matrices with Lipschitz constraints, which ensure that output changes remain bounded and stable in response to any perturbation in the input data. This constraint prevents large fluctuations in the output, thereby enhancing the monotonic neural network model's stability and predictability, particularly when dealing with noisy or inconsistent data. Additionally, the monotonic neural network model incorporates a GroupSort activation function, which maintains a unit gradient over its entire domain, ensuring smooth and consistent learning.

In one or more embodiments, the monotonic neural network model implements Lipschitz constraints by normalizing each weight matrix with respect to its column-wise maximum weights. The normalization process confirms that the influence of each feature is scaled in a manner that prevents large, disproportionate output changes for small variations in the input. By constraining the weight matrices in this way, the monotonic neural network model maintains bounded sensitivity to input perturbations.

In one or more embodiments, the monotonic neural network model implements the GroupSort activation function, which enhances the model's ability to handle high-dimensional input data. GroupSort divides the input vectors into defined-length sub-vectors and performs internal sorting of the elements within each sub-vector. This sorting mechanism helps preserve the relative importance of the features within each segment, while maintaining a unit gradient across the function's domain.

At 306, the extraction module 212 extracts a plurality of features influencing the credit score.

The extraction process involves identifying and selecting relevant attributes, such as financial transaction patterns, credit utilization rates, payment histories, and asset ownership records, which have a direct impact on the credit score computation.

In some non-limiting embodiments, the extraction module 212 applies one or more feature selection techniques to consider the most significant features, while irrelevant or redundant data is filtered out, to enable the system 104 to focus on factors that provide the most predictive value in determining creditworthiness.

At 308, feature contribution scores quantifying magnitude and directionality of impact are generated by the generation module 214 for each of the plurality of features on the credit score.

The magnitude of the impact indicates the degree of influence a particular feature, such as payment history or credit utilization, exerts on the computed credit score, while the directionality of the impact denotes whether the feature positively or negatively impacts the score.

In one or more embodiments, the generation module 214 utilizes the XAI component to generate the feature contribution scores. The XAI component is configured to analyze the internal workings of the monotonic neural network model used in credit score computation, providing detailed insights into the role of each feature in influencing the final credit score. Through techniques such as, for example, Shapley values, LIME (Local Interpretable Model-agnostic Explanations), or Integrated Gradients, the XAI component quantifies the extent (magnitude) and direction (positive or negative) of each feature's impact.

In one or more embodiments, the generation module 214, to generate the feature contribution scores, computes a quantitative measure of influence for each of the plurality of features on the credit score, which determines the extent to which each feature contributes to the overall score and whether its influence is positive, enhancing the credit score, or negative, detracting from it. The generation module 214 may perform the analysis by leveraging mathematical and machine learning techniques, such as sensitivity analysis, gradient-based attribution, or explainability metrics like Shapley values.

At 310, the identification module 216 identifies a set of credit enhancement actions based on the feature contribution scores, using the LAM. The identification module 216 analyzes the ranked features and their respective quantitative measures of influence to determine actionable steps that the user can take to improve credit score.

For instance, if the feature contribution score highlights that ‘high credit utilization’ is negatively impacting the credit score, the identification module 216 may recommend actions such as reducing outstanding balances or requesting a higher credit limit to improve the utilization ratio. Similarly, if ‘on-time payments’ is identified as a significant positive influence, the identification module 216 might suggest automating payments to ensure continued timeliness.

In one or more embodiments, the identification module 216 identifies the set of credit enhancement actions by analyzing the feature contribution scores to identify features having negative impact on the credit score to determine specific actions that can improve the identified features.

The identification module 216 leverages the quantitative measures of influence associated with each feature, ensuring that the recommended actions are both relevant and impactful. In one or more embodiments, this process is further refined by the integration of advanced AI algorithms, which not only identify the features but also simulate the potential outcomes of various corrective actions. This enables the system 104 to recommend actions that are optimal for the user's specific financial situation.

The identification module 216 then estimates an expected credit score improvement for each specific action. The estimation involves calculating the potential positive impact of implementing the recommended action on the user's credit score. For instance, if reducing credit utilization is identified as an actionable step, the identification module 216 may calculate the projected increase in the credit score based on the percentage reduction in utilization.

To perform this estimation, the identification module 216 leverages historical data patterns, predictive algorithms, and the feature contribution scores generated by the system 104. It simulates hypothetical scenarios by modifying the values of negatively influencing features to reflect the effect of the corrective action. For example, by modeling a reduction in missed payments or an increase in payment consistency, the identification module 216 can predict how the user's credit score is likely to improve.

In some non-limiting embodiments, the identification module 216 utilizes a LAM to identify the set of credit enhancement actions. The LAM leverages a trained LLM based on transformer architecture, which inherently incorporates various NLP techniques for contextual understanding. By analyzing the feature contribution scores, the LLM interprets the specific credit improvement needs of the user. Through fine-tuning and integration with the LAM process, the LLM identifies features that negatively impact the credit score and determines corresponding corrective actions.

At 312, the output module 218 presents the identified set of credit enhancement actions and corresponding projected impact values via the UI 108.

In one or more embodiments, the output module 218 formats and organizes the data into a user-friendly and intuitive display, ensuring that the user can easily interpret the recommendations. For instance, the presentation may include a concise and clear description of each recommended credit enhancement action, such as, reduce outstanding credit card balance by 20%, quantitative projections indicating the estimated improvement in the user's credit score for each action, graphical elements such as bar charts, pie charts, or progress indicators may be used to visually represent the relative impact of each action on the credit score. Further, the output module 218 may rank the actions in order of their projected impact, enabling the user to focus on the most effective steps first.

The method and system represents a significant technical advancement by overcoming the limitations of traditional systems that rely on static, periodically reported data typically on a monthly basis by banking systems. Unlike such conventional approaches, the method and system leverages real-time data aggregation and analysis to provide instantaneous credit assessments. By incorporating advanced technologies, including AI-powered predictive models and real-time data streaming, the system ensures that credit evaluations are based on the most current information available.

By leveraging advanced AI and ML algorithms, the method and system achieves a significant improvement in the accuracy and reliability of credit score computations. Unlike traditional methods, which may rely on limited or outdated datasets, the system utilizes machine learning techniques to analyze large volumes of diverse financial data from multiple sources. This approach not only ensures that credit scores reflect a more holistic and up-to-date view of an individual's financial behavior but also minimizes biases and errors often associated with manual or rule-based systems. By integrating advanced analytics, the system delivers highly reliable creditworthiness assessments, enabling more informed decision-making for both individuals and financial service providers.

Additionally, the method and system is advantageous in that the incorporation of XAI features introduces a new level of transparency into the credit scoring process. Unlike traditional black-box models, the system provides users with clear, interpretable insights into how their credit scores are calculated and which factors have the most significant impact. By presenting detailed explanations of feature contributions and their influence on the credit score, the system empowers users to take informed actions to improve their financial standing.

The system's LAM feature enhances the user experience by offering personalized recommendations and actionable insights for improving credit scores. By analyzing the user's financial data and credit profile, the LAM identifies specific areas where improvements can be made such as updating personal information, reducing debt, or adjusting spending habits. The tailored suggestions enable individuals to take proactive and targeted steps to enhance their credit health. With clear guidance on how to address key factors influencing their credit score, users can make informed decisions to optimize their financial behaviors, ultimately driving better credit.

One of the significant advantages of the method and system is its user-friendly interface, that provides a seamless and intuitive experience for users to access their credit scores, explanations, and recommendations. This user-friendly interface enhances usability and accessibility, ensuring that individuals can easily navigate and interact with the system. By presenting complex data in a clear and understandable format, the interface enhances usability and accessibility, allowing users to navigate and interact with the system effortlessly. This ease of use not only improves the user experience but also encourages active engagement, empowering individuals to take charge of their credit health with confidence.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented system for credit score computation, the computer-implemented system comprising:
a processor;
a memory storing instructions that, when executed by the processor, cause the processor to:
receive financial data from a plurality of disparate data sources;
generate a unified data structure by aggregating the received financial data;
compute a credit score by applying a monotonic neural network model to the unified data structure, wherein the monotonic neural network model comprises weight matrices with Lipschitz constraints ensuring bounded output changes for any input perturbation, and a GroupSort activation function that maintains unit gradient over a function domain of the GroupSort activation function;
extract, from the unified data structure, a plurality of features influencing the credit score;
generate, using an explainable artificial intelligence (XAI) component, feature contribution scores quantifying magnitude and directionality of impact for each of the plurality of features on the credit score;
identify, using a language action model (LAM), a set of credit enhancement actions based on the feature contribution scores; and
present, via a user interface (UI), the identified set of credit enhancement actions and corresponding projected impact values.

2. The computer-implemented system of claim 1, wherein the processor is further configured to:
receive, via the UI, a selection of one or more credit enhancement actions from the identified set;
generate one or more API calls to execute the selected credit enhancement actions; and
update the credit score based on execution status of the API calls.

3. The computer-implemented system of claim 1, wherein the plurality of disparate data sources comprises financial transaction data from banking systems, credit report data from credit bureaus, asset ownership records, and business revenue data.

4. The computer-implemented system of claim 1, wherein:
the monotonic neural network model implements Lipschitz constraints by normalizing each weight matrix with respect to its column-wise maximum weights; and
the GroupSort activation function performs:
segmentation of input vectors into defined-length sub-vectors, internal sorting of elements within each sub-vector, and maintenance of unit gradient across the function domain to prevent convergence failures that occur in traditional activation functions at near-zero partial derivatives.

5. The computer-implemented system of claim 1, wherein generating the feature contribution scores comprises:
calculating, for each of the plurality of features, a quantitative measure of influence on the credit score;
determining whether each feature's influence is positive or negative; and
ranking the plurality of features based on their respective quantitative measures of influence.

6. The computer-implemented system of claim 1, wherein identifying the set of credit enhancement actions comprises:
analyzing the feature contribution scores to identify features having negative impact on the credit score;
determining specific actions that can improve the identified features; and
estimating an expected credit score improvement for each specific action.

7. The computer-implemented system of claim 2, wherein generating the one or more API calls comprises:
formatting API requests according to specifications of target financial systems;
establishing secure connections with the target financial systems; transmitting the formatted API requests; and
receiving and validating responses from the target financial systems.

8. The computer-implemented system of claim 1, wherein the processor is further configured to:
monitor, in real-time, changes in the financial data from the plurality of disparate data sources;
detect significant changes in one or more of the plurality of features based on the monitored changes; and
automatically recompute the credit score and update the feature contribution scores based on the detected significant changes.

9. The computer-implemented system of claim 1, wherein the instructions further cause the processor to:
generate, for each credit enhancement action in the identified set:
an explanation of causative relationship between the credit enhancement action and potential credit score improvement,
a quantitative projection of expected credit score change, and
a sequence of steps required for action execution.

10. The computer-implemented system of claim 1, wherein generating the unified data structure comprises:
standardizing data formats from the plurality of disparate data sources;
resolving conflicts between overlapping data from different sources;
identifying and handling missing or incomplete data; and
maintaining data consistency across all sources.

11. A computer-implemented method for credit score computation performed by a processor executing instructions stored in a memory, the computer-implemented method comprising:
receiving, via the processor, financial data from a plurality of disparate data sources over a network;
generating, in the memory, a unified data structure by aggregating the received financial data;
computing, using the processor, a credit score by:
applying a monotonic neural network model implemented in the memory to the unified data structure;
enforcing Lipschitz constraints by normalizing weight matrices with respect to column-wise maximum weights;
implementing a GroupSort activation function that segments and sorts input vectors while maintaining unit gradient;
extracting, using the processor from the unified data structure stored in the memory, a plurality of features influencing the credit score;
generating, using an explainable artificial intelligence (XAI) component executed by the processor, feature contribution scores quantifying magnitude and directionality of impact for each of the plurality of features on the credit score;
identifying, using a language action model (LAM) executed by the processor, a set of credit enhancement actions based on the feature contribution scores; and
presenting, via a user interface (UI) device coupled to the processor, the identified set of credit enhancement actions and corresponding projected impact values.

12. The computer-implemented method of claim 11, further comprising:
receiving, via the UI device, a selection of one or more credit enhancement actions;
generating, using the processor, one or more API calls to execute the selected credit enhancement actions; and
updating, in the memory, the credit score based on execution status of the API calls.

13. The computer-implemented method of claim 11, wherein generating the feature contribution scores comprises:
calculating, by the processor, for each of the plurality of features, a quantitative measure of influence on the credit score;
determining, using the XAI component, whether each feature's influence is positive or negative; and
ranking, in the memory, the plurality of features based on their respective quantitative measures of influence.

14. The computer-implemented method of claim 11, wherein identifying the set of credit enhancement actions comprises:
analyzing, using the processor, the feature contribution scores to identify features having negative impact on the credit score;
determining, using the LAM, specific actions that can improve the identified features; and
estimating, using the processor, an expected credit score improvement for each specific action.

15. The computer-implemented method of claim 12, wherein generating the one or more API calls comprises:
formatting, by the processor, API requests according to specifications of target financial systems;
establishing secure connections with the target financial systems;
transmitting, over the network, the formatted API requests; and
receiving and validating, by the processor, responses from the target financial systems.

16. The computer-implemented method of claim 11, further comprising:
monitoring, in real-time, changes in the financial data from the plurality of disparate data sources;
detecting, using the processor, significant changes in one or more of the plurality of features based on the monitored changes; and
automatically recomputing, using the monotonic neural network model, the credit score and updating the feature contribution scores based on the detected significant changes.

17. The computer-implemented method of claim 11, further comprising generating, by the processor for each credit enhancement action:
an explanation of causative relationship between the action and potential credit score improvement;
a quantitative projection of expected credit score change; and
a sequence of steps required for action execution.

18. The computer-implemented method of claim 11, wherein generating the unified data structure comprises:
standardizing, by the processor, data formats from the plurality of disparate data sources;
resolving, using the processor, conflicts between overlapping data from different sources;
identifying and handling, by the processor, missing or incomplete data; and
maintaining, in the memory, data consistency across all sources.
